(19) United States
(12) Patent Application Publication
(10) Pub. No.: US 2025/0020918 A1
(43) Pub. Date: Jan. 16, 2025

(54) HEAD-MOUNTED DEVICE AND EYE TRACKING METHOD FOR TRACKING EYEBALLS

(71) Applicant: ASTI GLOBAL INC., TAIWAN, Taichung City (TW)

(72) Inventor: CHIEN-SHOU LIAO, Taichung City (TW)

(21) Appl. No.: 18/751,403

(22) Filed: Jun. 24, 2024

Related U.S. Application Data
(60) Provisional application No. 63/526,449, filed on Jul. 12, 2023.

(51) Int. Cl. G02B 27/00; G02B 27/09; G02C 7/08; G02C 11/00; G06F 1/16; G06F 3/01

(52) U.S. Cl. CPC G02B 27/0093; G02B 27/0977; G02C 7/088; G02C 11/10; G06F 1/163; G06F 3/013

(57) ABSTRACT

A head-mounted device and an eye tracking method for tracking eyeballs are provided. The head-mounted device includes a device casing module, a signal control module, a first image capturing module and a second image capturing module. The device casing module includes a first eyeglass frame structure, a second eyeglass frame structure, a first eyeglass lens structure and a second eyeglass lens structure. The first image capturing module includes a plurality of first image sensors disposed on the first eyeglass frame structure for capturing a first eyeball image of a first eye through a first optical waveguide channel provided by the first eyeglass lens structure. The second image capturing module includes a plurality of second image sensors disposed on the second eyeglass frame structure for capturing a second eyeball image of a second eye through a second optical waveguide channel provided by the second eyeglass lens structure.

### CROSS-REFERENCE TO RELATED PATENT APPLICATION

This application claims the benefit of priority to the U.S. Provisional Patent Application Ser. No. 63/526,449, filed on Jul. 12, 2023, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a head-mounted device and an eye tracking method, and more particularly to a head-mounted device for tracking eyeballs and an eye tracking method for tracking eyeballs.

### BACKGROUND OF THE DISCLOSURE

In the related art, AR or VR head-mounted devices can provide users with different visual experiences. However, the head-mounted devices in the related art still have room for improvement.

### SUMMARY OF THE DISCLOSURE

In response to the above-referenced technical inadequacy, the present disclosure provides a head-mounted device and an eye tracking method for tracking eyeballs, which can track the eyeball positions of the left eye and the right eye of the user in real time.

In order to solve the above-mentioned problems, one of the technical aspects adopted by the present disclosure is to provide a head-mounted device for tracking eyeballs, which includes a device casing module, a signal control module, a first image capturing module and a second image capturing module. The device casing module includes a first eyeglass frame structure, a second eyeglass frame structure cooperating with the first eyeglass frame structure, a first eyeglass lens structure carried by the first eyeglass frame structure, and a second eyeglass lens structure carried by the second eyeglass frame structure. The signal control module is disposed in the device casing module. The first image capturing module is configured to cooperate with the device casing module and electrically connect to the signal control module. The second image capturing module is configured to cooperate with the device casing module and electrically connect to the signal control module. The first image capturing module includes a plurality of first image sensors disposed around the first eyeglass frame structure, and the second image capturing module includes a plurality of second image sensors disposed around the second eyeglass frame structure. When the head-mounted device is optionally configured to be worn by a user, the first image sensors are allowed to be configured through the signal control module to capture a first eyeball image of a first eye of the user through a first optical waveguide channel provided by the first eyeglass lens structure. When the head-mounted device is optionally configured to be worn by the user, the second image sensors are allowed to be configured through the signal control module to capture a second eyeball image of a second eye of the user through a second optical waveguide channel provided by the second eyeglass lens structure.

In order to solve the above-mentioned problems, another one of the technical aspects adopted by the present disclosure is to provide a head-mounted device for tracking eyeballs, which includes a device casing module, a signal control module, a first image capturing module and a second image capturing module. The device casing module includes a first eyeglass frame structure, a second eyeglass frame structure cooperating with the first eyeglass frame structure, a first eyeglass lens structure carried by the first eyeglass frame structure, and a second eyeglass lens structure carried by the second eyeglass frame structure. The signal control module is disposed in the device casing module. The first image capturing module is configured to cooperate with the device casing module and electrically connect to the signal control module. The second image capturing module is configured to cooperate with the device casing module and electrically connect to the signal control module. The first image capturing module includes a plurality of first image sensors disposed on the first eyeglass frame structure, and the second image capturing module includes a plurality of second image sensors disposed on the second eyeglass frame structure.

In order to solve the above-mentioned problems, yet another one of the technical aspects adopted by the present disclosure is to provide an eye tracking method, which includes: providing a head-mounted device, in which the head-mounted device includes a device casing module, a signal control module disposed in the device casing module, a first image capturing module electrically connected to the signal control module, and a second image capturing module electrically connected to the signal control module; capturing a first eyeball image of a first eye of a user through an optical waveguide transmission provided by the device casing module; and capturing a second eyeball image of a second eye of the user through the optical waveguide transmission provided by the device casing module. The device casing module includes a first eyeglass frame structure, a second eyeglass frame structure cooperating with the first eyeglass frame structure, a first eyeglass lens structure carried by the first eyeglass frame structure, and a second eyeglass lens structure carried by the second eyeglass frame structure. The first image capturing module includes a plurality of first image sensors disposed around the first eyeglass frame structure, and the second image capturing module includes a plurality of second image sensors disposed around the second eyeglass frame structure. When the head-mounted device is optionally configured to be worn by the user, the first image sensors are allowed to be configured through the signal control module to capture the first eyeball image of the first eye of the user through a first optical waveguide channel provided by the first eyeglass lens structure. When the head-mounted device is optionally configured to be worn by the user, the second image sensors are allowed to be configured through the signal control module to capture the second eyeball image of the second eye of the user through a second optical waveguide channel provided by the second eyeglass lens structure.

Therefore, in the head-mounted device for tracking eyeballs provided by the present disclosure, by virtue of “the first image capturing module including a plurality of first image sensors disposed on the first eyeglass frame structure” and “the second image capturing module including a plurality of second image sensors disposed on the second eyeglass frame structure,” when the head-mounted device is optionally configured to be worn by the user, the first image sensors are allowed to capture the first eyeball image of the first eye of the user through a first optical waveguide channel provided by the first eyeglass lens structure, and the second image sensors are allowed to be configured to capture the second eyeball image of the second eye of the user through a second optical waveguide channel provided by the second eyeglass lens structure, thereby tracking the eyeball positions of the user's left and right eyes in real time.

Furthermore, in the eye tracking method provided by the present disclosure, by virtue of “capturing the first eyeball image of the first eye of the user through the optical waveguide transmission provided by the device casing module” and “capturing the second eyeball image of the second eye of the user through the optical waveguide transmission provided by the device casing module,” when the head-mounted device is optionally configured to be worn by the user, the first image sensors are allowed to capture the first eyeball image of the first eye of the user through a first optical waveguide channel provided by the first eyeglass lens structure, and the second image sensors are allowed to be configured to capture the second eyeball image of the second eye of the user through a second optical waveguide channel provided by the second eyeglass lens structure, thereby tracking the eyeball positions of the user's left and right eyes in real time.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a functional block diagram of a head-mounted device for tracking eyeballs provided by the present disclosure;

FIG. 2 is a schematic perspective view of the head-mounted device for tracking eyeballs according to a first embodiment of the present disclosure;

FIG. 3 is another schematic perspective view of the head-mounted device for tracking eyeballs according to the first embodiment of the present disclosure;

FIG. 4 is a schematic exploded cross-sectional view of a first part (which is applied to the user's right eye area) or a second part (which is applied to the user's left eye area) of the head-mounted device for tracking eyeballs according to the first embodiment of the present disclosure;

FIG. 5 is a schematic assembled cross-sectional view of the first part (which is applied to the user's right eye area) or the second part (which is applied to the user's left eye area) of the head-mounted device for tracking eyeballs according to the first embodiment of the present disclosure;

FIG. 6 is a schematic view of the head-mounted device for tracking eyeballs that can be configured to capture the user's eyeball images through an external light source according to the first embodiment of the present disclosure;

FIG. 7 is a schematic view of the head-mounted device for tracking eyeballs that can be configured to capture the user's eyeball images through a first projection beam or a second projection beam according to the first embodiment of the present disclosure;

FIG. 8 is a flowchart of an eye tracking method provided by the first embodiment of the present disclosure;

FIG. 9 is a partial schematic front view of the head-mounted device for tracking eyeballs provided by a second embodiment of the present disclosure (when the user's eyeball moves to a first side position); and

FIG. 10 is a partial schematic front view of a head-mounted device for tracking eyeballs provided by the second embodiment of the present disclosure (when the user's eyeball moves to a second side position).

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

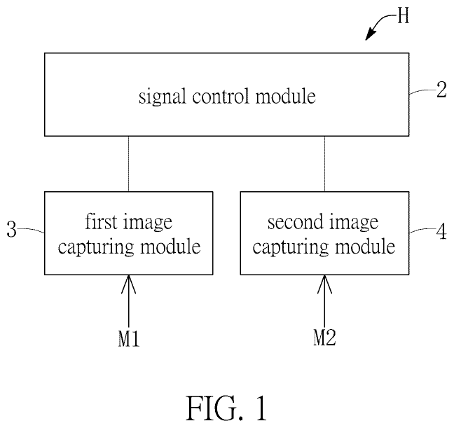

Referring to FIG. 1 to FIG. 10, in one of the feasible embodiments, the present disclosure provides a head-mounted device H for tracking eyeballs, which includes a device casing module 1, a signal control module 2, a first image capturing module 3 and a second image capturing module 4. More particularly, the device casing module 1 includes a first eyeglass frame structure 11, a second eyeglass frame structure 12 cooperating with the first eyeglass frame structure 11, a first eyeglass lens structure 13 carried or held by the first eyeglass frame structure 11, and a second eyeglass lens structure 14 carried or held by the second eyeglass frame structure 12. The signal control module 2 is disposed in the device casing module 1. The first image capturing module 3 can be configured to cooperate with the device casing module 1 and electrically connect to the signal control module 2, and the first image capturing module 3 includes a plurality of first image sensors 30 disposed on the first eyeglass frame structure 11. The second image capturing module 4 can be configured to cooperate with the device casing module 1 and electrically connect to the signal control module 2, and the second image capturing module 4 includes a plurality of second image sensors 40 disposed on the second eyeglass frame structure 12. Therefore, when the head-mounted device H is optionally configured to be worn by the user, the first image sensors 30 can be allowed to capture the first eyeball image M1 of the first eye E1 of the user through a first optical waveguide channel 1300 provided by the first eyeglass lens structure 13, and the second image sensors 40 can be allowed to be configured to capture the second eyeball image M2 of the second eye E2 of the user through a second optical waveguide channel 1400 provided by the second eyeglass lens structure 14, thereby tracking the eyeball positions of the user's left and right eyes in real time.

### First Embodiment

Referring to FIG. 1 to FIG. 8, a first embodiment of the present disclosure provides a head-mounted device H for tracking eyeballs, which includes a device casing module 1, a signal control module 2, a first image capturing module 3 and a second image capturing module 4. For example, the head-mounted device H can be the eyeglasses, so that the device casing module 1 can be an eyeglass casing structure. In one of the feasible embodiment, the head-mounted device H can be a goggle worn by the user when exercising or working, a swimming goggle, a snow goggle, a pilot goggle, a firefighter goggle, a military goggle, a medical goggle or any type of head-mounted device. However, the aforementioned details are disclosed for exemplary purposes only, and are not meant to limit the scope of the present disclosure.

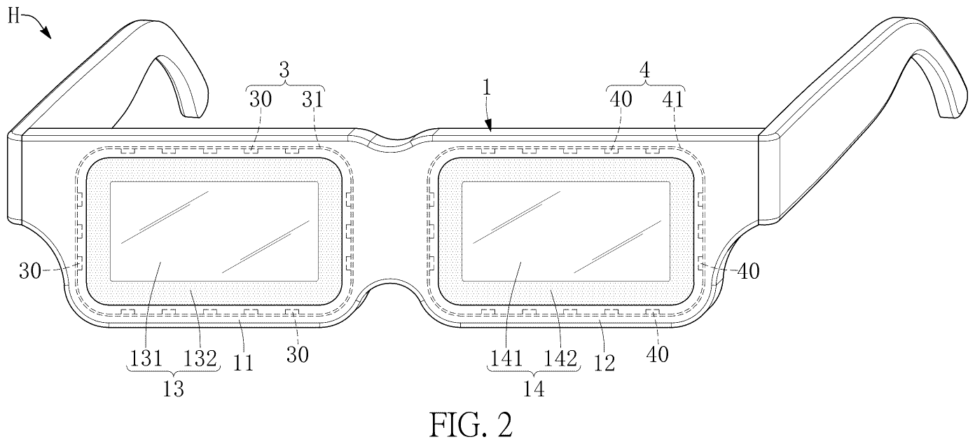

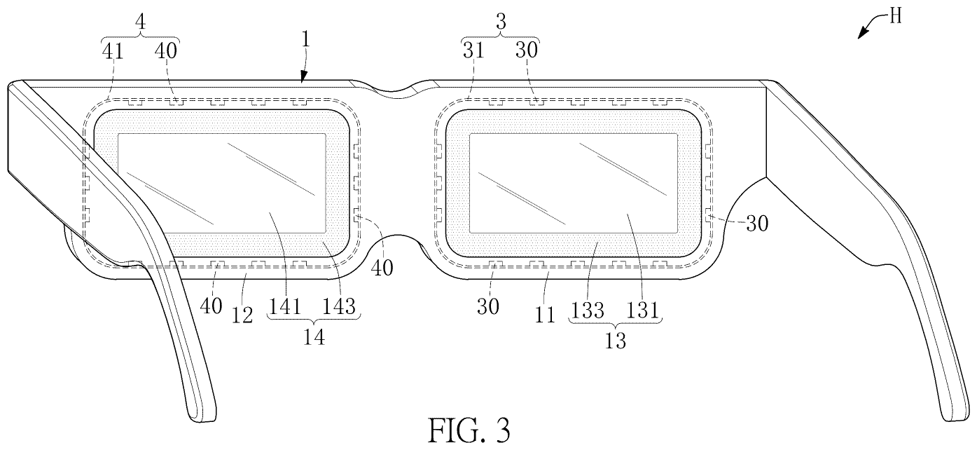

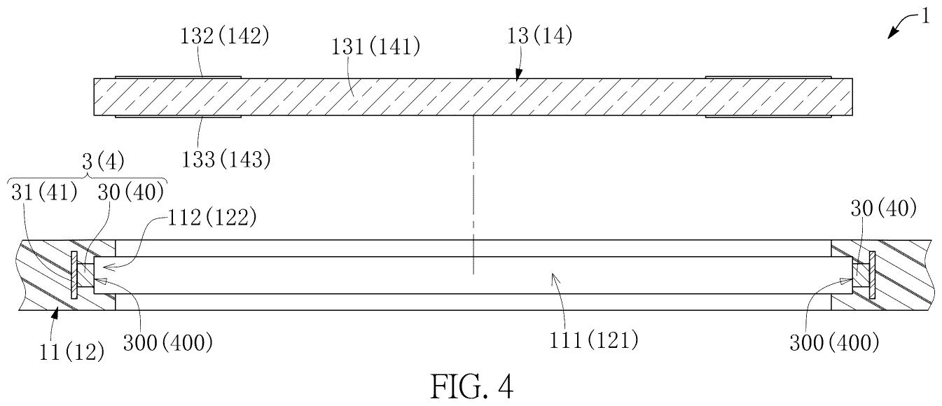

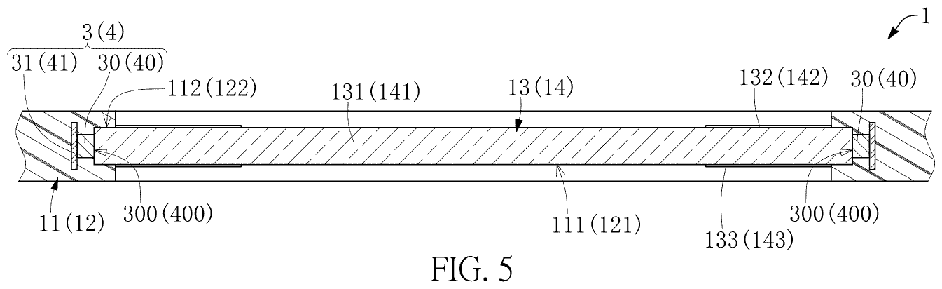

More particularly, referring to FIG. 2, FIG. 3, FIG. 4 and FIG. 5, when the head-mounted device H serves as the eyeglasses, the device casing module 1 includes a first eyeglass frame structure 11 (or a right eyeglass frame structure), a second eyeglass frame structure 12 (or a left eyeglass frame structure) cooperating with the first eyeglass frame structure 11, a first eyeglass lens structure 13 (or a right eyeglass lens structure) carried or held by the first eyeglass frame structure 11, and a second eyeglass lens structure 14 (or a left eyeglass lens structure) carried or held by the second eyeglass frame structure 12. For example, the first eyeglass frame structure 11 has a first lens accommodating space 111 and a first surrounding groove 112 communicated with (in air communication with) the first lens accommodating space 111, and the first eyeglass lens structure 13 can be detachably accommodated in the first lens accommodating space 111 and limited (or restricted) by the first surrounding groove 112. Moreover, the second eyeglass frame structure 12 has a second lens accommodating space 121 and a second surrounding groove 122 communicated with (in air communication with) the second lens accommodating space 121, and the second eyeglass lens structure 14 can be detachably accommodated in the second lens accommodating space 121 and limited (or restricted) by the second surrounding groove 122. Moreover, the first eyeglass lens structure 13 includes a first lens 131 (such as a first optical lens with or without prescription), a first external reflective layer 132 disposed on a first outer surface (or a first outer surface facing away from the user) of the first lens 131, and a first internal reflective layer 133 disposed on a first inner surface (or a first inner surface facing the user) of the first lens 131. In addition, the second eyeglass lens structure 14 includes a second lens 141 (such as a second optical lens with or without prescription), a second external reflective layer 142 disposed on a second outer surface (or a second outer surface facing away from the user) of the second lens 141, and a second internal reflective layer 143 disposed on a second inner surface (or a second inner surface facing the user) of the second lens 141. However, the aforementioned details are disclosed for exemplary purposes only, and are not meant to limit the scope of the present disclosure.

More particularly, referring to FIG. 1, FIG. 2 and FIG. 5, the signal control module 2 is disposed in the device casing module 1, the first image capturing module 3 can be configured to cooperate with the device casing module 1 (for example, the first image capturing module 3 can be detachably disposed on the device casing module 1) and electrically connect to the signal control module 2, and the second image capturing module 4 can be configured to cooperate with the device casing module 1 (for example, the second image capturing module 4 can be detachably disposed on the device casing module 1) and electrically connect to the signal control module 2. For example, the signal control module 2 can use a central processing unit (CPU), a digital signal processor (DSP), a microprocessor (MPU), a microcontroller (MCU) or any type of control chip with any type of memory. Moreover, the first image capturing module 3 includes a plurality of first image sensors 30 disposed around the first eyeglass frame structure 11, the first image sensors 30 can be surroundingly arranged inside or outside the first surrounding groove 112, and each of the first image sensors 30 has a first sensing area 300 facing the first lens 131 of the first eyeglass lens structure 13. Moreover, the second image capturing module 4 includes a plurality of second image sensors 40 disposed around the second eyeglass frame structure 12, the second image sensors 40 can be surroundingly arranged inside or outside of the second surrounding groove 122, and each of the second image sensors 40 has a second sensing area 400 facing the second lens 141 of the second eyeglass lens structure 14. In addition, the first image capturing module 3 and the second image capturing module 4 can be charge-coupled device (CCD) image sensors, complementary metal oxide semiconductor (CMOS) image sensors, or any type of image sensor. It should be noted that in a feasible embodiment, the first image capturing module 3 further includes a first circuit substrate 31 surroundingly arranged inside or outside the first surrounding groove 112, and the first image sensors 30 can be sequentially arranged on the first circuit substrate 31 so as to surround the first lens 131 of the first eyeglass lens structure 13. In addition, the second image capturing module 4 further includes a second circuit substrate 41 surroundingly arranged inside or outside the second surrounding groove 122, and the second image sensors 40 can be sequentially arranged on the second circuit substrate 41 so as to surround the second lens 141 of the second eyeglass lens structure 14. However, the aforementioned details are disclosed for exemplary purposes only, and are not meant to limit the scope of the present disclosure.

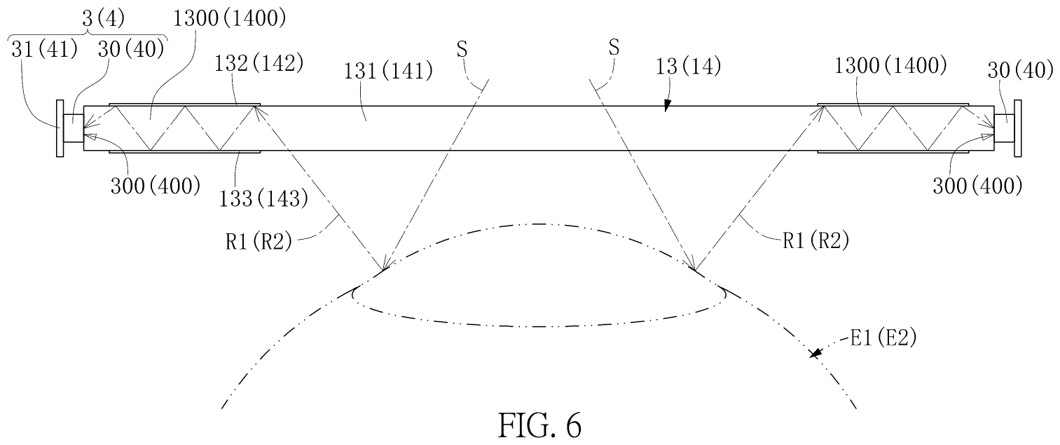

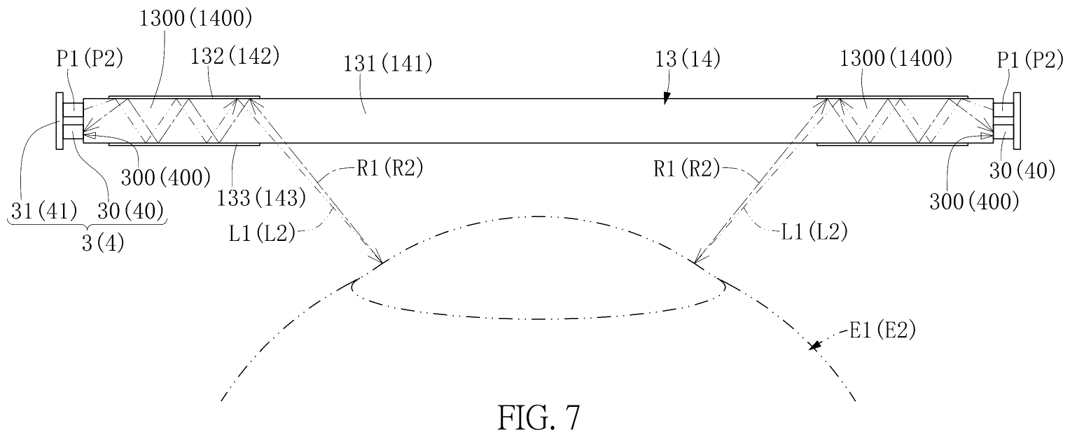

Therefore, referring to FIG. 1, FIG. 5, FIG. 6 and FIG. 7, when the head-mounted device H is optionally configured to be worn by a user, the first image sensors 30 can be allowed to be configured through the signal control module 2 to capture or obtain a first eyeball image M1 (a right eyeball image) of a first eye E1 of the user through a first optical waveguide channel 1300 (or a first optical transmission channel) provided by the first eyeglass lens structure 13, and the second image sensors 40 can be allowed to be configured through the signal control module 2 to capture or obtain a second eyeball image M2 (a left eyeball image) of a second eye E2 of the user through a second optical waveguide channel 1400 (or a second optical transmission channel) provided by the second eyeglass lens structure 14, thereby tracking the eyeball positions of the left eye and the right eye of the user in real time. More particularly, when the first image sensors 30 can be configured to capture the first eyeball image M1 of the first eye E1 of the user, a first eyeball reflected light R1 (or a plurality of first eyeball reflected beams R1) generated from or by the first eye E1 can be reflected multiple times between the first external reflective layer 132 and the first internal reflective layer 133 of the first eyeglass lens structure 13 (or can be transmitted within the first optical waveguide channel 1300) and then is projected onto the first image sensors 30. In addition, when the second image sensors 40 can be configured to capture the second eyeball image M2 of the second eye E2 of the user, a second eyeball reflected light R2 (or a plurality of second eyeball reflected beams R2) generated from the second eye E2 can be reflected multiple times between the second external reflective layer 142 and the second internal reflective layer 143 of the second eyeglass lens structure 14 (or can be transmitted within the second optical waveguide channel 1400) and then is projected onto the second image sensors 40.

For example, referring to FIG. 1, FIG. 5, FIG. 6 and FIG. 7, when the first image sensors 30 can be configured to capture the first eyeball image M1 of the first eye E1 of the user, an external light source S (such as ambient light as shown in FIG. 6) or a first projection beam L1 (or a plurality of first projection beams L1) provided by a plurality of first light-emitting chips P1 (such as a plurality of first LED chips or a plurality of first infrared LED chips arranged surroundingly) of the head-mounted device H (as shown in FIG. 7) can be reflected by the first eye E1 to generate a first eyeball reflected light R1 (or a plurality of first eyeball reflected beams R1), and the first eyeball reflected light R1 can be reflected multiple times between the first external reflective layer 132 and the first internal reflective layer 133 of the first eyeglass lens structure 13 (or can be transmitted within the first optical waveguide channel 1300) and then is projected onto the first image sensors 30. In addition, when the second image sensors 40 can be configured to capture the second eyeball image M2 of the second eye E2 of the user, the external light source S (as shown in FIG. 6) or a second projection beam L2 (or a plurality of second projection beams L2) provided by a plurality of second light-emitting chips P2 (such as a plurality of second LED chips or a plurality of second infrared LED chips arranged surroundingly) of the head-mounted device H (as shown in FIG. 7) can be reflected by the second eye E2 to generate a second eyeball reflected light R2, and the second eyeball reflected light R2 (or a plurality of second eyeball reflected beams R2) can be reflected multiple times between the second external reflective layer 142 and the second internal reflective layer 143 of the second eyeglass lens structure 14 (or can be transmitted within the second optical waveguide channel 1400) and then is projected onto the second image sensors 40.

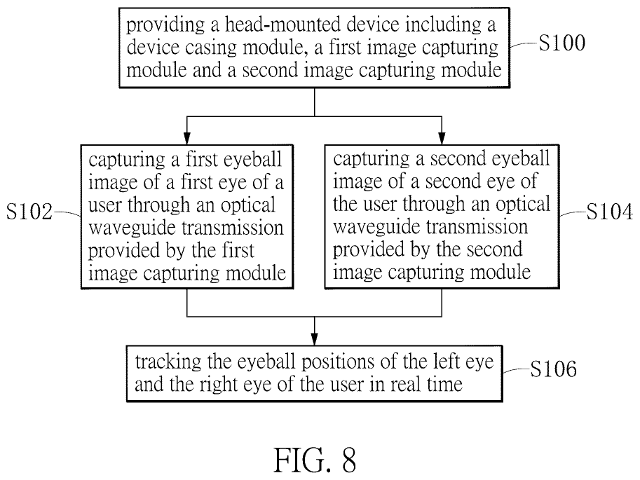

Furthermore, referring to FIG. 1, FIG. 6, FIG. 7 and FIG. 8, the first embodiment of the present disclosure further provides an eye tracking method (or an eyeball tracking method), which includes: firstly, referring to FIG. 1 and FIG. 8, providing a head-mounted device H, in which the head-mounted device H includes a device casing module 1, a signal control module 2 disposed in the device casing module 1, a first image capturing module 3 electrically connected to the signal control module 2, and a second image capturing module 4 electrically connected to the signal control module 2 (step S100); next, referring to FIG. 6, FIG. 7 and FIG. 8, capturing a first eyeball image M1 of a first eye E1 of a user through an optical waveguide transmission provided by the first image capturing module 3 including a plurality of first image sensors 30 (step S102); and then referring to FIG. 6, FIG. 7 and FIG. 8, capturing a second eyeball image M2 of a second eye E2 of the user through an optical waveguide transmission provided by the second image capturing module 4 including a plurality of second image sensors 40 (step S104). That is to say, when the head-mounted device H is optionally configured to be worn by the user, the first image sensors 30 of the first image capturing module 3 can be allowed to be configured through the signal control module 2 to capture the first eyeball image M1 of the first eye E1 of the user through a first optical waveguide channel 1300 (or a first optical transmission channel) provided by the first eyeglass lens structure 13, and the second image sensors 40 of the second image capturing module 4 can be allowed to be configured through the signal control module 2 to capture the second eyeball image M2 of the second eye E2 of the user through a second optical waveguide channel 1400 (or a second optical transmission channel) provided by the second eyeglass lens structure 14, thereby tracking the eyeball positions of the left eye and the right eye of the user in real time (step S106).

### Second Embodiment

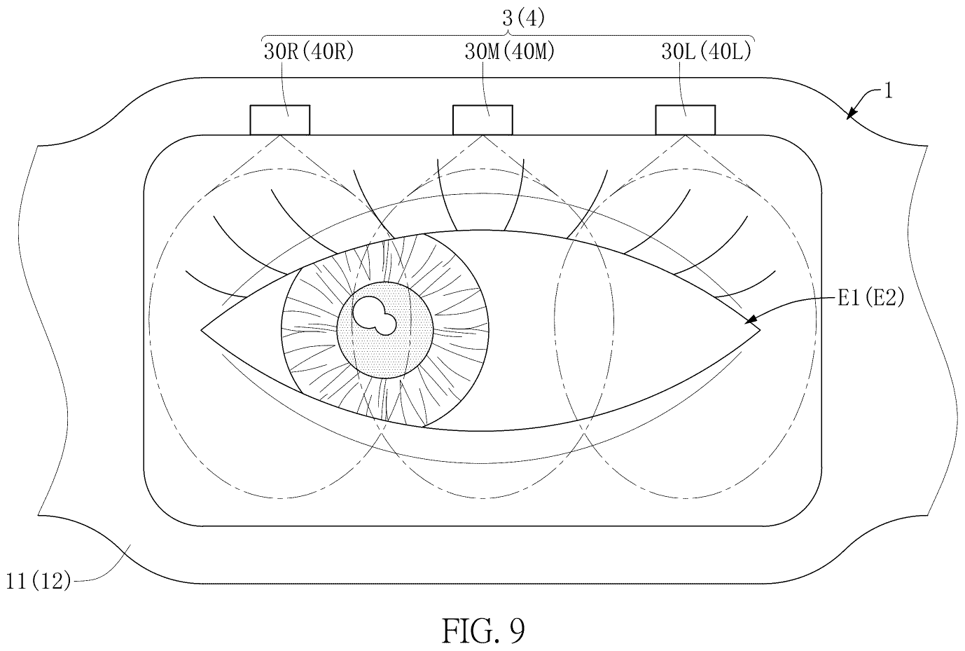

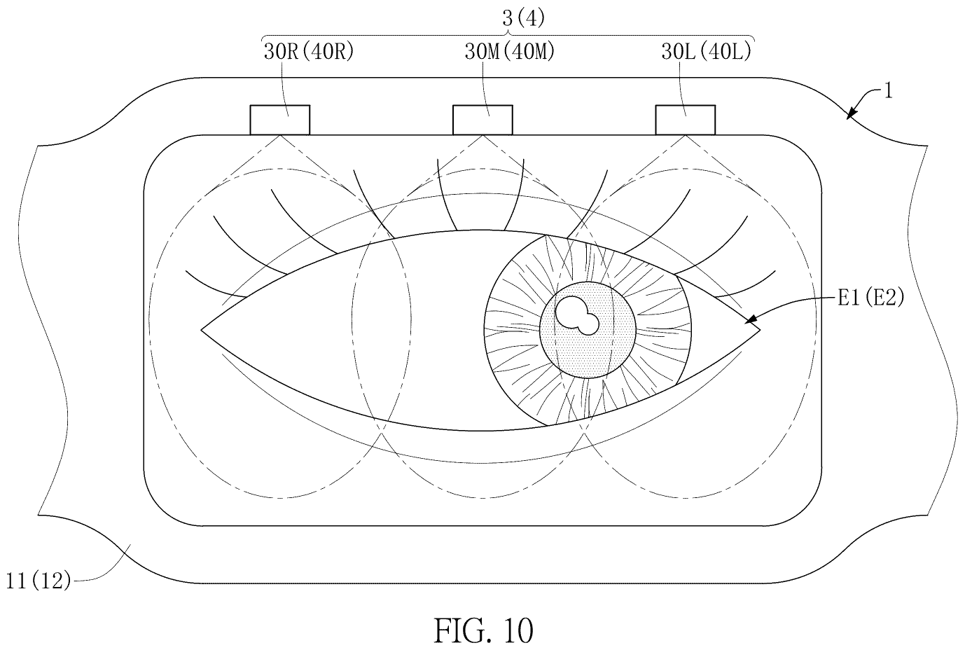

Referring to FIG. 1, FIG. 9 and FIG. 10, a second embodiment of the present disclosure provides a head-mounted device H for tracking eyeballs. Comparing FIG. 9 with FIG. 2, the main difference between the second embodiment and the first embodiment is as follows: in the second embodiment, the first image sensors 30 of the first image capturing module 3 can be at least divided into a first middle image sensor 30M, a first left image sensor 30L and a first right image sensor 30R, and the second image sensors 40 of the second image capturing module 4 can be at least divided into a second middle image sensor 40M, a second left image sensor 40L and a second right image sensor 40R. It should be noted that the first image capturing module 3 can be configured to directly capture the eyeball image of the user's right eye without using the first eyeglass lens structure 13, and the second image capturing module 4 can be configured to directly capture the eyeball image of the user's left eye without using the second eyeglass lens structure 14.

More particularly, referring to FIG. 9 and FIG. 10, the first middle image sensor 30M can be configured to capture a middle area image of the first eye E1, the first left image sensor 30L can be configured to capture a left area image of the first eye E1, and the first right image sensor 30R can be configured to capture a right area image of the first eye E1. It should be noted that regardless of whether the user's first eye E1 is in a first side position (as shown in FIG. 9) or a second side position (as shown in FIG. 10), the signal control module 2 can be configured to process the middle area image that is captured by the first middle image sensor 30M, the left area image that is captured by the first left image sensor 30L and the right area image that is captured by the first right image sensor 30R, thereby obtaining the first eyeball image M1 of the first eye E1 of the user.

More particularly, referring to FIG. 9 and FIG. 10, the second middle image sensor 40M can be configured to capture a middle area image of the second eye E2, the second left image sensor 40L can be configured to capture a left area image of the second eye E2, and the second right image sensor 40R can be configured to capture a right area image of the second eye E2. It should be noted that regardless of whether the user's second eye E2 is in a first side position (as shown in FIG. 9) or a second side position (as shown in FIG. 10), the signal control module 2 can be configured to process the middle area image that is captured by the second middle image sensor 40M, the left area image that is captured by the second left image sensor 40L and the right area image that is captured by the second right image sensor 40R, thereby obtaining the second eyeball image M2 of the second eye E2 of the user.

### Beneficial Effects of the Embodiments

In conclusion, in the head-mounted device H for tracking eyeballs provided by the present disclosure, by virtue of “the first image capturing module 3 including a plurality of first image sensors 30 disposed on the first eyeglass frame structure 11” and “the second image capturing module 4 including a plurality of second image sensors 40 disposed on the second eyeglass frame structure 12,” when the head-mounted device H is optionally configured to be worn by the user, the first image sensors 30 can be allowed to capture the first eyeball image M1 of the first eye E1 of the user through a first optical waveguide channel 1300 provided by the first eyeglass lens structure 13, and the second image sensors 40 can be allowed to be configured to capture the second eyeball image M2 of the second eye E2 of the user through a second optical waveguide channel 1400 provided by the second eyeglass lens structure 14, thereby tracking the eyeball positions of the user's left and right eyes in real time.

Furthermore, in the eye tracking method provided by the present disclosure, by virtue of “capturing the first eyeball image M1 of the first eye E1 of the user through the optical waveguide transmission provided by the device casing module 1” and “capturing the second eyeball image M2 of the second eye E2 of the user through the optical waveguide transmission provided by the device casing module 1,” when the head-mounted device H is optionally configured to be worn by the user, the first image sensors 30 can be allowed to capture the first eyeball image M1 of the first eye E1 of the user through a first optical waveguide channel 1300 provided by the first eyeglass lens structure 13, and the second image sensors 40 can be allowed to be configured to capture the second eyeball image M2 of the second eye E2 of the user through a second optical waveguide channel 1400 provided by the second eyeglass lens structure 14, thereby tracking the eyeball positions of the user's left and right eyes in real time.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A head-mounted device for tracking eyeballs, comprising:
a device casing module including a first eyeglass frame structure, a second eyeglass frame structure cooperating with the first eyeglass frame structure, a first eyeglass lens structure carried by the first eyeglass frame structure, and a second eyeglass lens structure carried by the second eyeglass frame structure;
a signal control module disposed in the device casing module;
a first image capturing module configured to cooperate with the device casing module and electrically connect to the signal control module; and
a second image capturing module configured to cooperate with the device casing module and electrically connect to the signal control module;
wherein the first image capturing module includes a plurality of first image sensors disposed around the first eyeglass frame structure, and the second image capturing module includes a plurality of second image sensors disposed around the second eyeglass frame structure;
wherein, when the head-mounted device is optionally configured to be worn by a user, the first image sensors are allowed to be configured through the signal control module to capture a first eyeball image of a first eye of the user through a first optical waveguide channel provided by the first eyeglass lens structure;
wherein, when the head-mounted device is optionally configured to be worn by the user, the second image sensors are allowed to be configured through the signal control module to capture a second eyeball image of a second eye of the user through a second optical waveguide channel provided by the second eyeglass lens structure.

2. The head-mounted device for tracking eyeballs according to claim 1,
wherein the first eyeglass frame structure has a first lens accommodating space and a first surrounding groove communicated with the first lens accommodating space, and the first eyeglass lens structure is detachably accommodated in the first lens accommodating space and limited by the first surrounding groove;
wherein the second eyeglass frame structure has a second lens accommodating space and a second surrounding groove communicated with the second lens accommodating space, and the second eyeglass lens structure is detachably accommodated in the second lens accommodating space and limited by the second surrounding groove;
wherein the first eyeglass lens structure includes a first lens, a first external reflective layer disposed on a first outer surface of the first lens, and a first internal reflective layer disposed on a first inner surface of the first lens;
wherein the second eyeglass lens structure includes a second lens, a second external reflective layer disposed on a second outer surface of the second lens, and a second internal reflective layer disposed on a second inner surface of the second lens;
wherein, when the first image sensors are configured to capture the first eyeball image of the first eye of the user, a first eyeball reflected light generated from the first eye is reflected multiple times between the first external reflective layer and the first internal reflective layer of the first eyeglass lens structure and then is projected onto the first image sensors;
wherein, when the second image sensors are configured to capture the second eyeball image of the second eye of the user, a second eyeball reflected light generated from the second eye is reflected multiple times between the second external reflective layer and the second internal reflective layer of the second eyeglass lens structure and then is projected onto the second image sensors.

3. The head-mounted device for tracking eyeballs according to claim 1,
wherein the first eyeglass frame structure has a first lens accommodating space and a first surrounding groove communicated with the first lens accommodating space, and the first eyeglass lens structure is detachably accommodated in the first lens accommodating space and limited by the first surrounding groove;
wherein the second eyeglass frame structure has a second lens accommodating space and a second surrounding groove communicated with the second lens accommodating space, and the second eyeglass lens structure is detachably accommodated in the second lens accommodating space and limited by the second surrounding groove;
wherein the first eyeglass lens structure includes a first lens, a first external reflective layer disposed on a first outer surface of the first lens, and a first internal reflective layer disposed on a first inner surface of the first lens;
wherein the second eyeglass lens structure includes a second lens, a second external reflective layer disposed on a second outer surface of the second lens, and a second internal reflective layer disposed on a second inner surface of the second lens;
wherein, the first image sensors are surroundingly arranged inside or outside the first surrounding groove, and each of the first image sensors has a first sensing area facing the first lens of the first eyeglass lens structure;
wherein, the second image sensors are surroundingly arranged inside or outside of the second surrounding groove, and each of the second image sensors has a second sensing area facing the second lens of the second eyeglass lens structure;
wherein the first image capturing module includes a first circuit substrate surroundingly arranged inside or outside the first surrounding groove, and the first image sensors are sequentially arranged on the first circuit substrate to surround the first lens of the first eyeglass lens structure;
wherein the second image capturing module includes a second circuit substrate surroundingly arranged inside or outside the second surrounding groove, and the second image sensors are sequentially arranged on the second circuit substrate to surround the second lens of the second eyeglass lens structure;
wherein, when the first image sensors are configured to capture the first eyeball image of the first eye of the user, an external light source or a first projection beam provided by the head-mounted device is reflected by the first eye to generate a first eyeball reflected light, and the first eyeball reflected light is reflected multiple times between the first external reflective layer and the first internal reflective layer of the first eyeglass lens structure and then is projected onto the first image sensors;
wherein, when the second image sensors are configured to capture the second eyeball image of the second eye of the user, the external light source or a second projection beam provided by the head-mounted device is reflected by the second eye to generate a second eyeball reflected light, and the second eyeball reflected light is reflected multiple times between the second external reflective layer and the second internal reflective layer of the second eyeglass lens structure and then is projected onto the second image sensors.

4. A head-mounted device for tracking eyeballs, comprising:
a device casing module including a first eyeglass frame structure, a second eyeglass frame structure cooperating with the first eyeglass frame structure, a first eyeglass lens structure carried by the first eyeglass frame structure, and a second eyeglass lens structure carried by the second eyeglass frame structure;
a signal control module disposed in the device casing module;
a first image capturing module configured to cooperate with the device casing module and electrically connect to the signal control module; and
a second image capturing module configured to cooperate with the device casing module and electrically connect to the signal control module;
wherein the first image capturing module includes a plurality of first image sensors disposed on the first eyeglass frame structure, and the second image capturing module includes a plurality of second image sensors disposed on the second eyeglass frame structure.

5. The head-mounted device for tracking eyeballs according to claim 4,
wherein the first eyeglass frame structure has a first lens accommodating space and a first surrounding groove communicated with the first lens accommodating space, and the first eyeglass lens structure is detachably accommodated in the first lens accommodating space and limited by the first surrounding groove;
wherein the second eyeglass frame structure has a second lens accommodating space and a second surrounding groove communicated with the second lens accommodating space, and the second eyeglass lens structure is detachably accommodated in the second lens accommodating space and limited by the second surrounding groove;
wherein the first eyeglass lens structure includes a first lens, a first external reflective layer disposed on a first outer surface of the first lens, and a first internal reflective layer disposed on a first inner surface of the first lens;
wherein the second eyeglass lens structure includes a second lens, a second external reflective layer disposed on a second outer surface of the second lens, and a second internal reflective layer disposed on a second inner surface of the second lens;
wherein, when the head-mounted device is optionally configured to be worn by a user, the first image sensors are allowed to be configured to capture a first eyeball image of a first eye of the user, and the second image sensors are allowed to be configured to capture a second eyeball image of a second eye of the user;
wherein, when the first image sensors are configured to capture the first eyeball image of the first eye of the user, a first eyeball reflected light generated from the first eye is reflected multiple times between the first external reflective layer and the first internal reflective layer of the first eyeglass lens structure and then is projected onto the first image sensors;
wherein, when the second image sensors are configured to capture the second eyeball image of the second eye of the user, a second eyeball reflected light generated from the second eye is reflected multiple times between the second external reflective layer and the second internal reflective layer of the second eyeglass lens structure and then is projected onto the second image sensors.

6. The head-mounted device for tracking eyeballs according to claim 4,
wherein the first eyeglass frame structure has a first lens accommodating space and a first surrounding groove communicated with the first lens accommodating space, and the first eyeglass lens structure is detachably accommodated in the first lens accommodating space and limited by the first surrounding groove;
wherein the second eyeglass frame structure has a second lens accommodating space and a second surrounding groove communicated with the second lens accommodating space, and the second eyeglass lens structure is detachably accommodated in the second lens accommodating space and limited by the second surrounding groove;
wherein the first eyeglass lens structure includes a first lens, a first external reflective layer disposed on a first outer surface of the first lens, and a first internal reflective layer disposed on a first inner surface of the first lens;
wherein the second eyeglass lens structure includes a second lens, a second external reflective layer disposed on a second outer surface of the second lens, and a second internal reflective layer disposed on a second inner surface of the second lens;
wherein, the first image sensors are surroundingly arranged inside or outside the first surrounding groove, and each of the first image sensors has a first sensing area facing the first lens of the first eyeglass lens structure;
wherein, the second image sensors are surroundingly arranged inside or outside of the second surrounding groove, and each of the second image sensors has a second sensing area facing the second lens of the second eyeglass lens structure;
wherein the first image capturing module includes a first circuit substrate surroundingly arranged inside or outside the first surrounding groove, and the first image sensors are sequentially arranged on the first circuit substrate to surround the first lens of the first eyeglass lens structure;
wherein the second image capturing module includes a second circuit substrate surroundingly arranged inside or outside the second surrounding groove, and the second image sensors are sequentially arranged on the second circuit substrate to surround the second lens of the second eyeglass lens structure;
wherein, when the head-mounted device is optionally configured to be worn by a user, the first image sensors are allowed to be configured to capture a first eyeball image of a first eye of the user, and the second image sensors are allowed to be configured to capture a second eyeball image of a second eye of the user;
wherein, when the first image sensors are configured to capture the first eyeball image of the first eye of the user, an external light source or a first projection beam provided by the head-mounted device is reflected by the first eye to generate a first eyeball reflected light, and the first eyeball reflected light is reflected multiple times between the first external reflective layer and the first internal reflective layer of the first eyeglass lens structure and then is projected onto the first image sensors;
wherein, when the second image sensors are configured to capture the second eyeball image of the second eye of the user, the external light source or a second projection beam provided by the head-mounted device is reflected by the second eye to generate a second eyeball reflected light, and the second eyeball reflected light is reflected multiple times between the second external reflective layer and the second internal reflective layer of the second eyeglass lens structure and then is projected onto the second image sensors.

7. The head-mounted device for tracking eyeballs according to claim 4,
wherein, when the head-mounted device is optionally configured to be worn by a user, the first image sensors are allowed to be configured to capture a first eyeball image of a first eye of the user, and the second image sensors are allowed to be configured to capture a second eyeball image of a second eye of the user;
wherein the first image sensors of the first image capturing module are at least divided into a first middle image sensor, a first left image sensor and a first right image sensor, the first middle image sensor is configured to capture a middle area image of the first eye, the first left image sensor is configured to capture a left area image of the first eye, and the first right image sensor is configured to capture a right area image of the first eye;
wherein the second image sensors of the second image capturing module are at least divided into a second middle image sensor, a second left image sensor and a second right image sensor, the second middle image sensor is configured to capture a middle area image of the second eye, the second left image sensor is configured to capture a left area image of the second eye, and the second right image sensor is configured to capture a right area image of the second eye;
wherein, the signal control module is configured to process the middle area image captured by the first middle image sensor, the left area image captured by the first left image sensor and the right area image captured by the first right image sensor, thereby obtaining the first eyeball image of the first eye of the user;
wherein, the signal control module is configured to process the middle area image captured by the second middle image sensor, the left area image captured by the second left image sensor and the right area image captured by the second right image sensor, thereby obtaining the second eyeball image of the second eye of the user.

8. An eye tracking method, comprising:
providing a head-mounted device, wherein the head-mounted device includes a device casing module, a signal control module disposed in the device casing module, a first image capturing module electrically connected to the signal control module, and a second image capturing module electrically connected to the signal control module;
capturing a first eyeball image of a first eye of a user through an optical waveguide transmission provided by the device casing module; and
capturing a second eyeball image of a second eye of the user through the optical waveguide transmission provided by the device casing module;
wherein the device casing module includes a first eyeglass frame structure, a second eyeglass frame structure cooperating with the first eyeglass frame structure, a first eyeglass lens structure carried by the first eyeglass frame structure, and a second eyeglass lens structure carried by the second eyeglass frame structure
wherein the first image capturing module includes a plurality of first image sensors disposed around the first eyeglass frame structure, and the second image capturing module includes a plurality of second image sensors disposed around the second eyeglass frame structure;
wherein, when the head-mounted device is optionally configured to be worn by the user, the first image sensors are allowed to be configured through the signal control module to capture the first eyeball image of the first eye of the user through a first optical waveguide channel provided by the first eyeglass lens structure;
wherein, when the head-mounted device is optionally configured to be worn by the user, the second image sensors are allowed to be configured through the signal control module to capture the second eyeball image of the second eye of the user through a second optical waveguide channel provided by the second eyeglass lens structure.

9. The eye tracking method according to claim 8,
wherein the first eyeglass frame structure has a first lens accommodating space and a first surrounding groove communicated with the first lens accommodating space, and the first eyeglass lens structure is detachably accommodated in the first lens accommodating space and limited by the first surrounding groove;
wherein the second eyeglass frame structure has a second lens accommodating space and a second surrounding groove communicated with the second lens accommodating space, and the second eyeglass lens structure is detachably accommodated in the second lens accommodating space and limited by the second surrounding groove;
wherein the first eyeglass lens structure includes a first lens, a first external reflective layer disposed on a first outer surface of the first lens, and a first internal reflective layer disposed on a first inner surface of the first lens;
wherein the second eyeglass lens structure includes a second lens, a second external reflective layer disposed on a second outer surface of the second lens, and a second internal reflective layer disposed on a second inner surface of the second lens;
wherein, when the first image sensors are configured to capture the first eyeball image of the first eye of the user, a first eyeball reflected light generated from the first eye is reflected multiple times between the first external reflective layer and the first internal reflective layer of the first eyeglass lens structure and then is projected onto the first image sensors;
wherein, when the second image sensors are configured to capture the second eyeball image of the second eye of the user, a second eyeball reflected light generated from the second eye is reflected multiple times between the second external reflective layer and the second internal reflective layer of the second eyeglass lens structure and then is projected onto the second image sensors.

10. The eye tracking method according to claim 8,
wherein the first eyeglass frame structure has a first lens accommodating space and a first surrounding groove communicated with the first lens accommodating space, and the first eyeglass lens structure is detachably accommodated in the first lens accommodating space and limited by the first surrounding groove;
wherein the second eyeglass frame structure has a second lens accommodating space and a second surrounding groove communicated with the second lens accommodating space, and the second eyeglass lens structure is detachably accommodated in the second lens accommodating space and limited by the second surrounding groove;
wherein the first eyeglass lens structure includes a first lens, a first external reflective layer disposed on a first outer surface of the first lens, and a first internal reflective layer disposed on a first inner surface of the first lens;
wherein the second eyeglass lens structure includes a second lens, a second external reflective layer disposed on a second outer surface of the second lens, and a second internal reflective layer disposed on a second inner surface of the second lens;
wherein, the first image sensors are surroundingly arranged inside or outside the first surrounding groove, and each of the first image sensors has a first sensing area facing the first lens of the first eyeglass lens structure;
wherein, the second image sensors are surroundingly arranged inside or outside of the second surrounding groove, and each of the second image sensors has a second sensing area facing the second lens of the second eyeglass lens structure;
wherein the first image capturing module includes a first circuit substrate surroundingly arranged inside or outside the first surrounding groove, and the first image sensors are sequentially arranged on the first circuit substrate to surround the first lens of the first eyeglass lens structure;
wherein the second image capturing module includes a second circuit substrate surroundingly arranged inside or outside the second surrounding groove, and the second image sensors are sequentially arranged on the second circuit substrate to surround the second lens of the second eyeglass lens structure;
wherein, when the first image sensors are configured to capture the first eyeball image of the first eye of the user, an external light source or a first projection beam provided by the head-mounted device is reflected by the first eye to generate a first eyeball reflected light, and the first eyeball reflected light is reflected multiple times between the first external reflective layer and the first internal reflective layer of the first eyeglass lens structure and then is projected onto the first image sensors;
wherein, when the second image sensors are configured to capture the second eyeball image of the second eye of the user, the external light source or a second projection beam provided by the head-mounted device is reflected by the second eye to generate a second eyeball reflected light, and the second eyeball reflected light is reflected multiple times between the second external reflective layer and the second internal reflective layer of the second eyeglass lens structure and then is projected onto the second image sensors.
